(19) United States
(12) Patent Application Publication
(10) Pub. No.: US 2019/0203944 A1
(43) Pub. Date: Jul. 4, 2019

(54) COOKER AND CONTROL METHOD THEREOF

(71) Applicant: SAMSUNG ELECTRONICS CO., LTD., Suwon-si, Gyeonggi-do (KR)

(72) Inventors: Jin-Hee CHO, Suwon-si (KR); Ga-Young JO, Seoul (KR); Kum-Chul HWANG, Bucheon-si (KR)

(73) Assignee: SAMSUNG ELECTRONICS CO., LTD., Suwon-si, Gyeonggi-do (KR)

(21) Appl. No.: 16/331,730

(22) PCT Filed: Aug. 22, 2017
(86) PCT No.: PCT/KR2017/009146

§ 371 Date: Mar. 8, 2019

(30) Foreign Application Priority Data
Sep. 9, 2016 (KR) 10- 2016-0116209

(51) Int. Cl. F24C 3/12; B08B 3/02; B08B 3/04; F24C 7/08; F24C 14/00; F24C 15/00

(52) U.S. Cl. CPC F24C 3/128; B08B 3/02; B08B 3/04; B08B 2230/01; F24C 14/005; F24C 15/003; F24C 7/085

(57) ABSTRACT

There is provided a cooker including: a cooking room; a steam generator configured to generate steam, and to supply the steam to the cooking room; a water level sensor configured to sense a water level of a cleaning solution stored in the inside of the steam generator; a supply apparatus including a storage unit configured to accommodate the cleaning solution, a supply pump configured to supply the cleaning solution accommodated in the storage unit to the steam generator, and a drain pump configured to supply the cleaning solution remaining in the steam generator to the storage unit; and a controller configured to control operations of the supply pump and the drain pump, wherein the controller operates the supply pump in a washing mode, operates the drain pump when the cleaning solution is fully filled in the steam generator, and again operates the supply pump when the cleaning solution is removed from the steam generator.

### TECHNICAL FIELD

The present disclosure relates to a cooker and a control method thereof.

### BACKGROUND ART

An oven, which is cooking equipment of sealing up and heating a cooking material to cook it, is generally classified into an electric oven, a gas oven, and an electronic oven (also, called a microwave) according to heat sources. The electric oven uses an electric heater as a heat source, and the gas oven and the microwave use heat generated by gas and friction heat of water molecules generated by high-frequency waves, respectively, as heat sources.

The oven includes a cooking room that cooks food and a machine room that accommodates electronic components. During a process of cooking food, the inside of the cooking room is sealed up to prevent high-temperature heat from escaping to the outside.

Recently, a cooker including a steam generator for providing steam to the inside of a cooking room during cooking to cook food indirectly by steam heat in order to improve the texture of the food and reduce the loss of nutrients included in the food has been developed.

However, there is a case in which impurities are attached on the surface of the steam generator when the steam generator is driven for a long time, and the impurities influence the durability of the steam generator.

### DISCLOSURE

### Advantageous Effects

An embodiment of the present disclosure is directed to providing a cooker of effectively removing impurities in a steam generator, and a method of controlling the cooker.

Also, since impurities existing in the steam generator can be removed by circulating a cleaning solution without turning on a heater, energy saving is possible.

### DESCRIPTION OF DRAWINGS

FIG. 1 is a perspective view showing a cooker according to an embodiment.

FIG. 2 is a perspective view of a cooker according to an embodiment when a cover of the cooker is removed, as seen from one side.

FIG. 3 is a perspective view of a cooker according to an embodiment when a cover of the cooker is removed, as seen from another side.

FIG. 4 is a perspective view showing a steam generator and an auxiliary steam generator of a cooker according to an embodiment.

FIG. 5 is a perspective view showing a steam generator of a cooker according to an embodiment.

FIG. 6 is an exploded perspective view showing a steam generator of a cooker according to an embodiment.

FIG. 7 is a perspective view showing a cooker according to another embodiment.

FIG. 8 is a perspective view showing a cooker according to another embodiment when the cooker is partially dissembled.

FIGS. 9 and 10 show a state of a supply apparatus when a door according to another embodiment operates.

FIG. 11 is a rear perspective view of a cooker according to another embodiment when the cooker is partially dissembled.

FIG. 12 is a control block diagram of a cooker according to an embodiment.

FIG. 13 is a schematic diagram for describing a control process of a cooker according to an embodiment when a washing mode and a rinsing mode are performed.

FIG. 14 is a flowchart illustrating a control method of a cooker according to an embodiment when a washing mode is performed.

FIG. 15 is a flowchart illustrating a control method of a cooker according to an embodiment when a rinsing mode is performed.

### MODES OF THE INVENTION

Hereinafter, like reference numerals will refer to like components throughout this specification. This specification does not describe all components of the embodiments, and general information in the technical field to which the present disclosure belongs or overlapping information between the embodiments will not be described. As used herein, the terms “portion”, “part, “module, “member” or “block” may be implemented as software or hardware, and according to embodiments, a plurality of “portions”, “parts, “modules, “members” or “blocks” may be implemented as a single component, or a single “portion”, “part, “module, “member” or “block” may include a plurality of components.

It will be understood that when a component is referred to as being “connected” to another component, it can be directly or indirectly connected to the other component. When a component is indirectly connected to another component, it may be connected to the other component through a wireless communication network.

Also, it will be understood that when the terms “includes,” “comprises,” “including,” and/or “comprising,” when used in this specification, specify the presence of a stated component, but do not preclude the presence or addition of one or more other components.

Also, it will be understood that, although the terms first, second, etc. may be used herein to describe various components, these components should not be limited by these terms. These terms are only used to distinguish one component from another.

It is to be understood that the singular forms “a,” “an,” and “the” include plural referents unless the context clearly dictates otherwise.

Reference numerals used in operations are provided for convenience of description, without describing the order of the operations, and the operations can be executed in a different order from the stated order unless a specific order is definitely specified in the context.

Also, the terms “front end”, “rear end”, “upper portion”, “lower portion”, “upper end”, and “lower end”, when used in this specification, are defined based on the drawings, and the shapes and locations of the corresponding components are not limited by the terms.

Hereinafter, embodiments will be described with reference to the accompanying drawings.

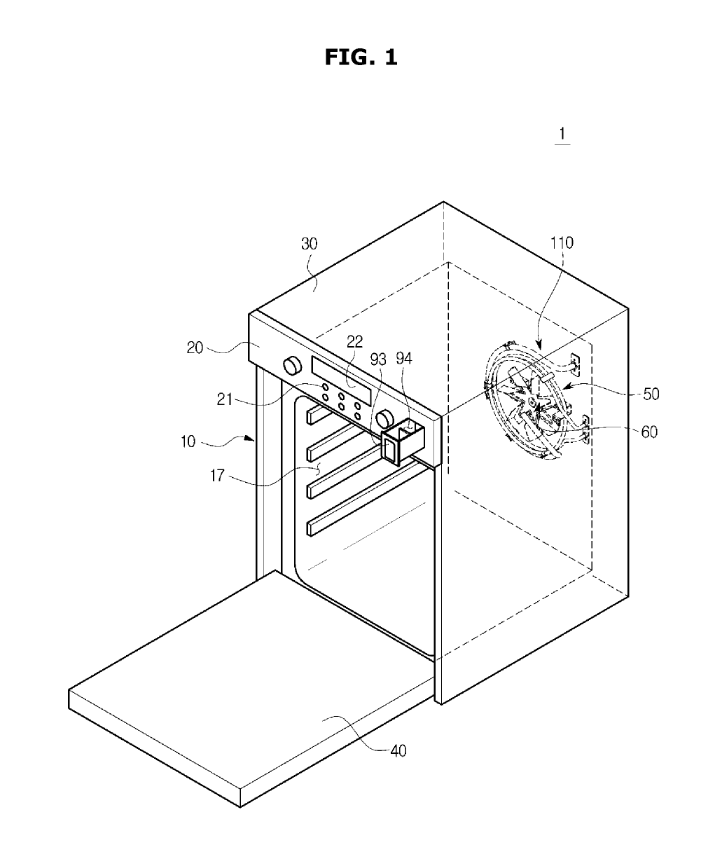

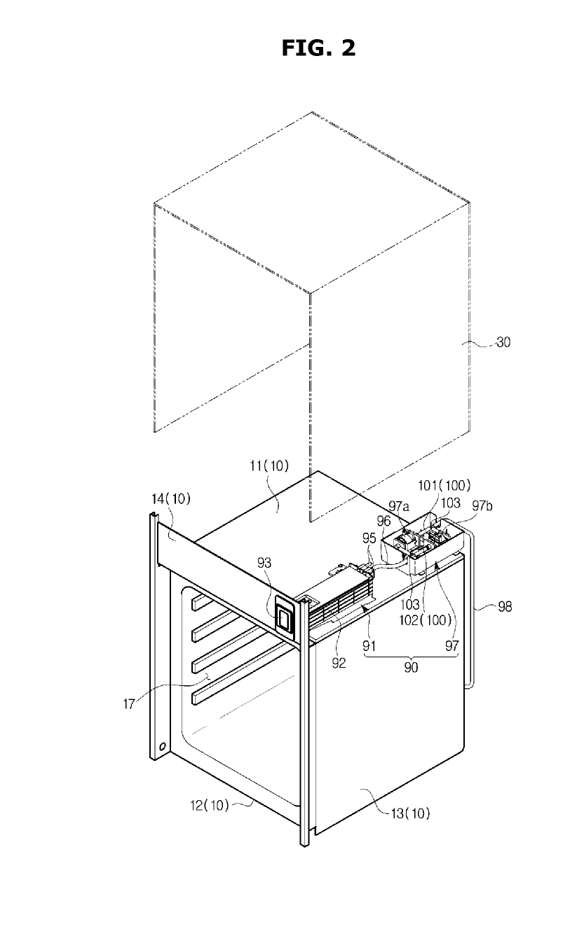

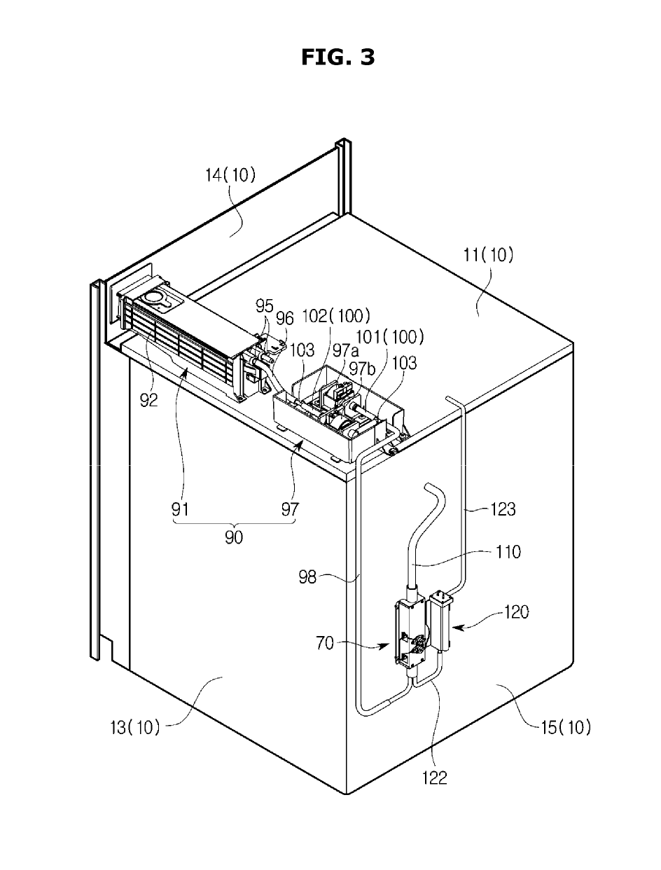

FIG. 1 is a perspective view showing a cooker according to an embodiment. FIG. 2 is a perspective view of a cooker according to an embodiment when a cover of the cooker is removed, as seen from one side. FIG. 3 is a perspective view of a cooker according to an embodiment when a cover of the cooker is removed, as seen from another side. A heater for heating a cooking room may include various kinds of heaters. For example, the heater may be a convection heater. Hereinafter, the heater is assumed to be a convection heater. However, the heater is not limited to a convection heater.

As shown in FIGS. 1 to 3, a cooker 1 may include a main body 10, a cover 30, a door 40, a convection heater 50, a convection fan 60, and a steam generator 70.

The main body 10 may be coupled with the cover 30 to form an outer appearance of the cooker 1. In the inside of the main body 10, a cooking room 17 may be provided.

Inner walls of the cooking room 17 may be coated to be prevented from being corroded due to condensed water that may be generated during condensation of at least one of steam and superheated steam or due to water, etc. contained in food. The inside of the cooking room 17 may be dried by heat generated during cooking.

One side of the main body 10 may open to allow a user to put food in the cooking room 17 or to take food out of the cooking room 17. In other words, the cooking room 17 provided in the inside of the main body 10 may have an open side to allow a user to put food in or take food out.

The main body 10 may include a plurality of frames. The plurality of frames may include a upper frame 11, a lower frame 12, a right frame 13, a left frame (not shown), a front frame 14, and a rear frame 15. A part of the front frame 14 may open to allow a user to put food in or take food out. The plurality of frames may be coupled with each other to form the main body 10.

The cover 30 may cover the main body 10. More specifically, the cover 30 may cover the upper frame 11, the right frame 13, the left frame (not shown), and the rear frame 15 of the main body 10. As described above, the cover 30 may be coupled with the main body 10 to form the outer appearance of the cooker 1.

The cooking room 17 in which food is cooked may be opened or closed by a door 40 coupled with a front portion of the main body 10. The door 40 may be rotatably coupled with the front portion of the main body 10. In other words, the door 40 may be rotatably coupled with the front frame 14 of the main body 10. The door 40 may be coupled with the front frame 14 to open or close an opening of the front frame 14.

In a front, upper portion of the main body 10, a control panel 20 including various operating switches 21 may be positioned to allow the user to control operations of the cooker 1. Also, in the control panel 20, a display 22 for displaying an operation state of the cooker 1 may be positioned. The display 22 may also function as a touch screen which is an input unit configured to execute a predetermined command when a user touches a specific part of the screen with his/her body part or a special tool. Accordingly, the user may operate at least one of the operating switches 21 and the display 22 to control operations of the cooker 1.

For example, the control panel 20 may receive a command for entering a washing mode or a command for entering a rinsing command. The washing mode and the rinsing mode will be described later.

The control panel 20 may be coupled with the front frame 14 of the main body 10.

Or, the control panel 20 may be integrated into the front frame 14 of the main body 10.

The convection heater 50 may be positioned on at least one wall of the main body 10 to heat the cooking room 17, in other words, food existing in the inside of the cooking room 17. The convection heater 50 may be positioned on at least one wall of the main body 10 to face the cooking room 17. The convection heater 50 may be installed or fixed on at least one wall of the main body 10. Preferably, the convection heater 50 may be installed or fixed on the rear frame 15 of the main body 10. However, a heater used to heat the cooking room 17 is not limited to the convection heater 50.

The convection heater 50 may be used for heating steam generated by the steam generator 70 to supply superheated steam to the cooking room 17, in addition to heating the cooking room 17. As such, since the convection heater 50 is used to generate superheated steam, no additional heater may need to be installed.

The convection fan 60 may be positioned in the main body 10 to circulate heat generated by the convection heater 50 in the inside of the cooking room 17. The convection fan 60 may be rotatably disposed on an inner wall of the main body 10. The convection fan 60 may be disposed in the main body 10 to circulate superheated steam heated by the convection heater 50, as well as heat generated by the convection heater 50, in the inside of the cooking room 17. In other words, the convection fan 60 may be rotatably disposed on an inner wall of the main body 10 to circulate at least one of heat generated by the convection heater 50 and superheated steam discharged through a steam outlet (not shown) in the inside of the cooking room 17. The convection fan 60 may be positioned on at least one inner wall of the main body 10 in such a way to face the cooking room 17. The convection fan 60 may be installed or fixed on at least one inner wall of the main body 10. Preferably, the convection fan 60 may be installed or fixed on the rear fame of the main body 10.

The numbers and positions of the convection heater 50 and the convection fan 60 may change.

The steam generator 70 may generate steam, and supply the generated steam to the inside of the cooking room 17. The steam generator 70 may heat water supplied by a supply apparatus 90 to generate steam.

The steam generator 70 may be disposed on an outer side of the main body 10. More specifically, the steam generator 70 may be positioned on an outer surface of the rear frame 15 of the main body 10. In other words, the steam generator 70 may be positioned between the rear frame 15 of the main body 10 and the cover 30. The steam generator 70 may face at least one of the convection heater 50 and the convection fan 60 with one wall of the main body 10 in between. That is, the steam generator 70 may face at least one of the convection heater 50 and the convection fan 60 with the rear frame 15 of the main body 10 in between. However, the steam generator 70 may be disposed at another location. Details about the steam generator 70 will be described later.

The supply apparatus 90 may supply water or a solution such as a cleaning solution to the steam generator 70. The supply apparatus 90 may be positioned on the main body 10. The supply apparatus 90 may be positioned between the main body 10 and the cover 30. More specifically, the supply apparatus 90 may be positioned between the upper frame 11 of the main body 10 and the cover 30. The supply apparatus 90 may be fixed on the main body 10. That is, the supply apparatus 90 may be fixed on the upper frame 11 of the main body 10.

The supply apparatus 90 may include a storage unit 91 and at least one pump 97.

The storage unit 91 may be configured to be taken out of the main body 10. More specifically, the storage unit 91 may be configured to be taken out forward from the front portion of the main body 10. That is, the storage unit 91 may be configured to be taken out forward from the front frame 14 or the control panel 20 of the main body 10. The storage unit 91 may be positioned in front of at least one pump 97. The user may take out the storage unit 91 to supply a solution to the steam generator 70 or to remove a solution existing in the steam generator 70.

The storage unit 91 may include a holder 92, and a slider 93 coupled with the holder 92 and configured to slide to enter the inside of the holder 92.

The holder 92 may be coupled with the main body 10. More specifically, the holder 92 may be coupled with or fixed on at least one of the front frame 14 and the upper frame 11 of the main body 10. In the inside of the holder 92, a slider accommodating portion (not shown) may be provided to accommodate the slider 93. In the inside of the slider accommodating portion (not shown), a rail portion (not shown) may be provided on which the slider 92 slides.

The slider 93 may include an accommodating portion 94 for accommodating a solution supplied from the outside, and a connecting portion 95 protruding to a predetermined length outward from the rear portion of the accommodating portion 94. A connecting pipe 96 may be connected to the connecting portion 95. The connecting pipe 96 may connect the storage unit 91 to the at least one pump 97. The connecting pipe 96 may be made of a material that is easily bent and that is not easily deformed by repeated movements, since the connecting pipe 96 moves together with the slider 93 when the slider 93 is taken out forward from the main body 10 or inserted in the inside of the main body 10. For example, the connecting pipe 96 may be made of a synthetic resin or rubber.

The storage unit 91 may further include a sensor (not shown) coupled with one side of the holder 92 to sense a movement of the slider 93.

The at least one pump 97 may be positioned between the storage unit 91 and the steam generator 70 to provide a driving force for moving a solution between the storage unit 91 and the steam generator 70. The at least one pump 97 may be positioned behind the storage unit 91. The at least one pump 97 may be coupled with the main body 10. More specifically, the at least one pump 97 may be coupled with or fixed on the upper frame 11 of the main body 10.

The at least one pump 97 may include a supply pump 97a and a drain pump 97b. The supply pump 97a may supply a solution stored in the accommodating portion 94 to the steam generator 70. The drain pump 97b may supply a solution remaining in the steam generator 70 to the accommodating portion 94. The supply pump 97a and the drain pump 97b may participate in movements of a solution between the accommodating portion 94 and an auxiliary steam generator 120, as well as movements of a solution between the accommodating portion 94 and the steam generator 70. That is, the supply pump 97a may supply a solution stored in the accommodating portion 94 to the steam generator 70 and the auxiliary steam generator 120, and the drain pump 97b may supply a solution remaining in the steam generator 70 and the auxiliary steam generator 120 to the accommodating portion 94.

The supply apparatus 90 may be connected to the steam generator 70 through a supply pipe 98. More specifically, the at least one pump 97 may be connected to the steam generator 70 through the supply pipe 98.

The connecting pipe 96 connected to the storage unit 91 may diverge to connect to the at least one pump 97. That is, the connecting pipe 96 connected to the storage unit 91 may diverge to connect to the supply pump 97a and the drain pump 97b, respectively. The supply pipe 98 connected to the steam generator 70 may diverge to connect to the at least one pump 97. That is, the supply pipe 98 connected to the steam generator 70 may diverge to connect to the supply pump 97a and the drain pump 97b, respectively.

The cooker 1 may further include the auxiliary steam generator 120.

The auxiliary steam generator 120 may be adjacent to the steam generator 70. In the auxiliary steam generator 120, a water level sensor 121 may be disposed to measure a water level of solution stored in the inside of the steam generator 70. Details about the auxiliary steam generator 70 will be described later.

The cooker 1 may further include a flow path 100.

The flow path 100 may connect the supply apparatus 90 to the steam generator 70.

The flow path 100 may include a supply path 101 and a drain path 102. A solution supplied to the accommodating portion 94 of the storage unit 91 may move toward the steam generator 70 along the supply path 101. More specifically, a solution accommodated in the accommodating portion 94 of the storage unit 91 may be transferred to the supply pump 97a through the connecting pipe 96, and the solution passed through the supply pump 97a may move to the steam generator 70 through the supply pipe 98. A solution remaining in the steam generator 70 may move toward the accommodating portion 94 of the storage unit 91 along the drain path 102. More specifically, a solution remaining in the steam generator 70 may be transferred to the drain pump 97b through the supply pipe 98, and a solution passed through the drain pump 97b may move to the accommodating portion 94 of the storage unit 91 through the connecting pipe 96.

The supply path 101 may intersect the drain path 102 to form at least one intersection 103. The at least one intersection 103 may be formed at a diverging point of the connecting pipe 96 and the supply pipe 98.

The supply pump 97a may be positioned on the supply path 101. The drain pump 97b may be positioned on the drain path 102.

The connecting pipe 96 and the supply pipe 98 may be positioned on the flow path 100.

The cooker 1 may further include a steam supply pipe 110 connecting the steam generator 70 to the cooking room 17 to supply steam discharged from the steam generator 70 to the cooking room 17. Steam discharged from the steam generator 70 may be heated when it moves along the steam supply pipe 110 to be converted to superheated steam. The steam supply pipe 110 may penetrate one wall of the main body 10 to connect the steam generator 70 to the cooking room 17. More specifically, the steam supply pipe 110 may penetrate the rear frame 15 of the main body 10 to connect the steam generator 70 to the cooking room 17.

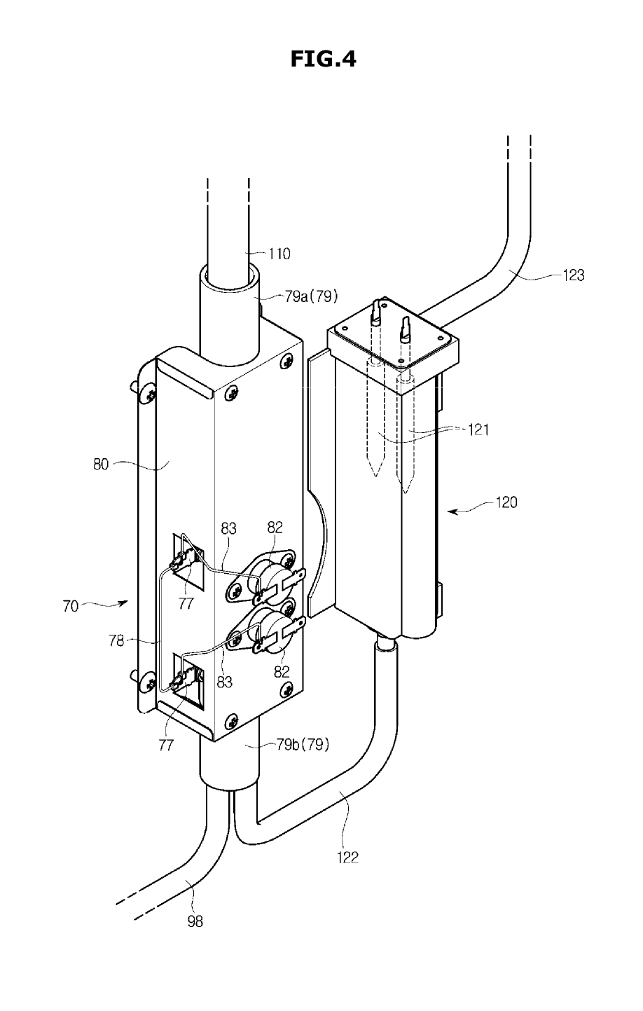

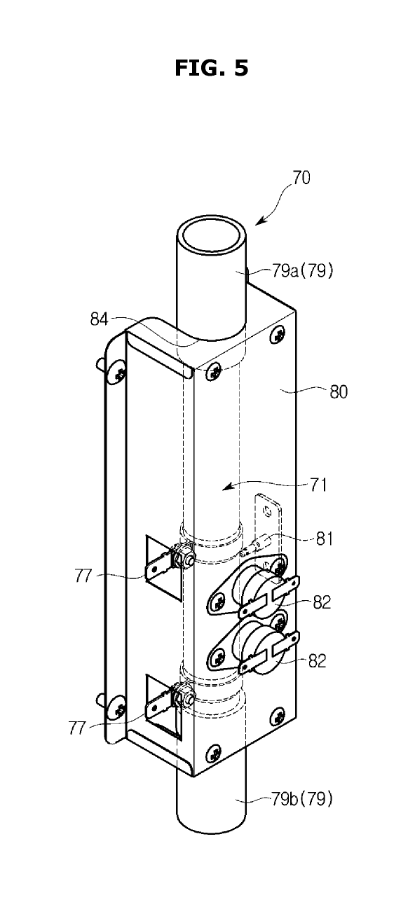

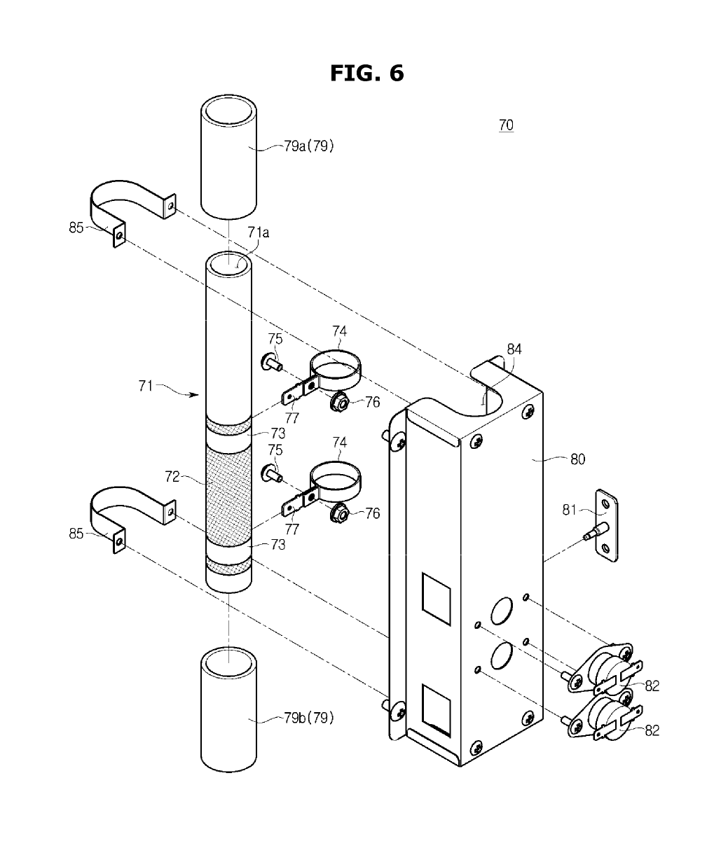

FIG. 4 is a perspective view showing a steam generator and an auxiliary steam generator of a cooker according to an embodiment. FIG. 5 is a perspective view showing a steam generator of a cooker according to an embodiment. FIG. 6 is an exploded perspective view showing a steam generator of a cooker according to an embodiment. Hereinafter, reference numerals not shown in the drawings will be understood by referring to FIGS. 1 to 3.

On the outer side of the cooking room 17, the steam generator 70 and the auxiliary steam generator 120 may be provided. In other words, the steam generator 70 and the auxiliary steam generator 120 may be positioned between the rear frame 15 of the main body 10 and the cover 30. However, the steam generator 70 and the auxiliary steam generator 120 may be positioned at other locations.

The steam generator 70 may include a heating pipe 71.

The steam generator 70 may include at least one heating pipe 71.

One end of the heating pipe 71 may be connected to the supply pipe 98, and the other end of the heating pipe 71 may be connected to the steam supply pipe 110.

In the inside of the heating pipe 71, a cavity 71a may be provided to move a solution supplied to the steam generator 70 through the supply pipe 98.

The heating pipe 71 may include a heating layer 72. The heating layer 72 may be formed on at least one surface of the heating pipe 71. The heating layer 72 may be applied as a coating formed on at least one surface of the heating pipe 71. The heating layer 72 may be in the form of a thin film. Preferably, the heating layer 72 may have a thickness of 100 nm or less, although not limited thereto. Also, the heating layer 72 may be formed with a material having high power density. Preferably, the heating layer 72 may include metal oxide, although not limited thereto. As such, since the heating layer 72 applied in the form of a thin film and having high power density can generate heat rapidly reaching high temperature, the heating layer 72 may convert a solution moving along the cavity 71a of the heating pipe 71 to steam.

The heating pipe 71 may be positioned on the rear frame 15. The heating pipe 71 may be positioned vertically on the rear frame 15. That is, the heating pipe 71 may be positioned on the rear frame 15 in a height direction of the cooking room 17.

Or, the heating pipe 71 may be disposed horizontally on the rear frame 15. That is, the heating pipe 71 may be disposed on the rear frame 15 in a width direction of the cooking room 17.

Or, the heating pipe 71 may be disposed obliquely on the rear frame 15. More specifically, the heating pipe 71 may be disposed on the rear frame 15 in such a way to be inclined with respect to the height direction of the cooking room 17. Or, the heating pipe 71 may be disposed on the rear frame 15 in such a way to be inclined with respect to the width direction of the cooking room 17.

The heating layer 72 may be formed on a surface of the heating pipe 71 to correspond to an area at which a solution supplied to the steam generator 70 through the supply pipe 98 and moving along the cavity 71a contacts the cavity 71a. The heating layer 72 may prevent the heating pipe 71 from being overheated unnecessarily. For example, when the heating pipe 71 is disposed on the rear frame 15 in the width direction of the cooking room 17, a solution supplied through the supply pipe 98 may be collected in the lower end of the cavity 71a, and the upper end of the cavity 71a which is in non-contact with the solution supplied through the supply pipe 98 may be overheated. To prevent such a phenomenon, the heating layer 72 may be formed on the surface of the heating pipe 71 to correspond to the lower end of the cavity 71a which a solution supplied through the supply pipe 98 contacts.

The steam generator 70 may further include a plurality of electrodes 73.

The plurality of electrodes 73 may be positioned on the surface of the heating pipe 71. The plurality of electrodes 73 may be spaced apart from each other on the surface of the heating pipe 71. More specifically, the plurality of electrodes 73 may be disposed on the heating layer 72 in such a way to be spaced a predetermined distance from each other. The plurality of electrodes 73 may be processed with silver paste to be applied a voltage from a power source (not shown). The plurality of electrodes 73 may be connected to the power source (not shown) to cause current to flow through the heating layer 72, thereby raising temperature of the heating layer 72.

The steam generator 70 may further include a plurality of connectors 74.

The plurality of connectors 74 may be positioned on the plurality of electrodes 73. The plurality of connectors 74 may be combined with the heating pipe 71 to correspond to locations at which the plurality of electrodes 73 are positioned. The plurality of connectors 74 may be fixed on the plurality of electrodes 73 by coupling of bolts 75 and nuts 76. The plurality of connectors 74 may include a plurality of coupling terminals. The coupling terminals 77 provided in the plurality of connectors 74 may be connected to wires 78 (see FIG. 4) through which current can flow. The plurality of connectors 74 and the coupling terminals 77 may be made of a material through which current can flow.

The steam generator 70 may further include a connecting member 79.

The connecting member 79 may include a first connecting member 79a connecting the supply pipe 98 to the heating pipe 71, and a second connecting member 79b connecting the steam supply pipe 110 to the heating pipe 71. The connecting member 79 may firmly couple the supply pipe 98 with the heating pipe 71 and also firmly couple the steam supply pipe 110 with the heating pipe 71, thereby preventing water, etc. from leaking out.

The steam generator 70 may further include a case 80.

The heating pipe 71 may be positioned in the inside of the case 80. The heating pipe 71 may be positioned between the rear frame 15 and the case 80. The heating pipe 71 may be fixed at a heating pipe resting portion 84 formed in the case 80 by a coupling member 85. The case 80 may be fixed on the rear frame 15 in the state in which the heating pipe 71 is fixed at the heating pipe resting portion 84 of the case 80.

The steam generator 70 may further include a temperature sensor 81 for measuring temperature of the heating pipe 71. The temperature sensor 81 may be positioned on one side of the case 80 to measure temperature of the heating layer 72. However, the location of the temperature sensor 81 is not limited to one side of the case 80, and the temperature sensor 81 may be positioned at another location.

The steam generator 70 may further include an overheating preventing sensor 82. A plurality of overheating preventing sensors 82 may be provided. The overheating preventing sensors 82 may block flow of current physically to prevent the heating layer 72 from being overheated to predetermined temperature or higher. Any one of the plurality of overheating preventing sensors 82 may be connected to any one coupling terminal 77 of the plurality of connectors 74, and the other one of the plurality of overheating preventing sensors 82 may be connected to the other coupling terminal 77 of the plurality of connectors 74. The plurality of overheating preventing sensors 82 may be connected to the coupling terminals 77 of the plurality of connectors 74 by wires 83. The overheating preventing sensors 82 may be installed on the case 80. However, the location of the overheating preventing sensors 82 is not limited to on the case 80, and the overheating preventing sensors 82 may be positioned at another location.

The auxiliary steam generator 120 may be positioned beside the steam generator 70. The auxiliary steam generator 120 may be connected to the steam generator 70 through a flow path pipe 122, and a water level sensor 121 for measuring a level of a solution stored in the inside of the steam generator 70 may be coupled with the auxiliary steam generator 120. A reason why the auxiliary steam generator 120 for measuring a level of a solution stored in the inside of the steam generator 70 is provided is because when the water level sensor 121 is coupled with the steam generator 70 and operates, a higher water level than an actual water level may be measured due to the pressure of steam generated in the inside of the steam generator 70, etc.

The water level sensor 121 may include a ground electrode and a sensing electrode. When a solution stored in the inside of the steam generator 70 reaches a predetermined water level, the sensing electrode of the water level sensor 121 may contact the solution to generate a voltage. Accordingly, when the water level sensor 121 senses a water level of the solution filled in the inside of the steam generator 70, an amount of the solution may be estimated.

A solution entered the inside of the heating pipe 71 may enter the inside of the auxiliary steam generator 120 through the water path pipe 122, and since the inside of the auxiliary steam generator 120 communicates with the outside through a communicating pipe 123, a water level (a height from a bottom surface on which the cooker 1 is installed to the surface of the solution stored in the inside of the steam generator 70) of the solution stored in the inside of the steam generator 70 may become substantially equal to a water level (a height from the bottom surface of the cooker 1 is installed to the surface of a solution stored in the inside of the auxiliary steam generator 120) of a solution stored in the inside of the auxiliary steam generator 120. Accordingly, by measuring a water level of the solution stored in the inside of the auxiliary steam generator 120, a water level of the solution stored in the inside of the steam generator 70 may be determined.

Superheated steam means steam generated by heating saturated steam to higher temperature than saturation temperature under static pressure. In other words, superheated steam means steam generated by heating saturated steam generated under atmospheric pressure of 100° C. to higher temperature. Superheated steam may be supplied to food during cooking. For example, superheated steam may be supplied to bread during a process of cooking the bread. A process of cooking bread may include at least one of a fermentation process and a heating process. When superheated steam is applied to bread during a process of cooking the bread, the surface of the bread may be prevented from being hardened. As a result, sufficient oven spring (a phenomenon in which the volume of a completely fermented bread dough increases during baking) may be expected to improve the flavor of the bread. According to another example, superheated steam may be applied to meat during a process of cooking the meat. When superheated steam is applied to meat during a process of cooking the meat, condensation heat of the superheated steam may be transferred to the meat so that the surface of the meat gets browned and crispy and the inside of the meat is moist. Since superheated steam has more condensation heat than steam (saturated steam), superheated steam may transfer more condensation heat to food than steam (saturated steam).

A user may freely adjust an injection time of superheated steam. The user may freely adjust an injection time of superheated steam to inject the superheated steam periodically or temporarily.

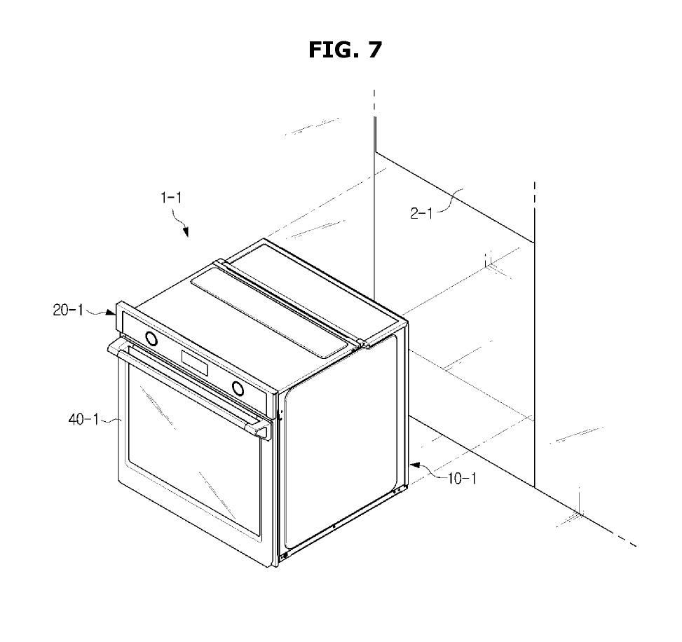

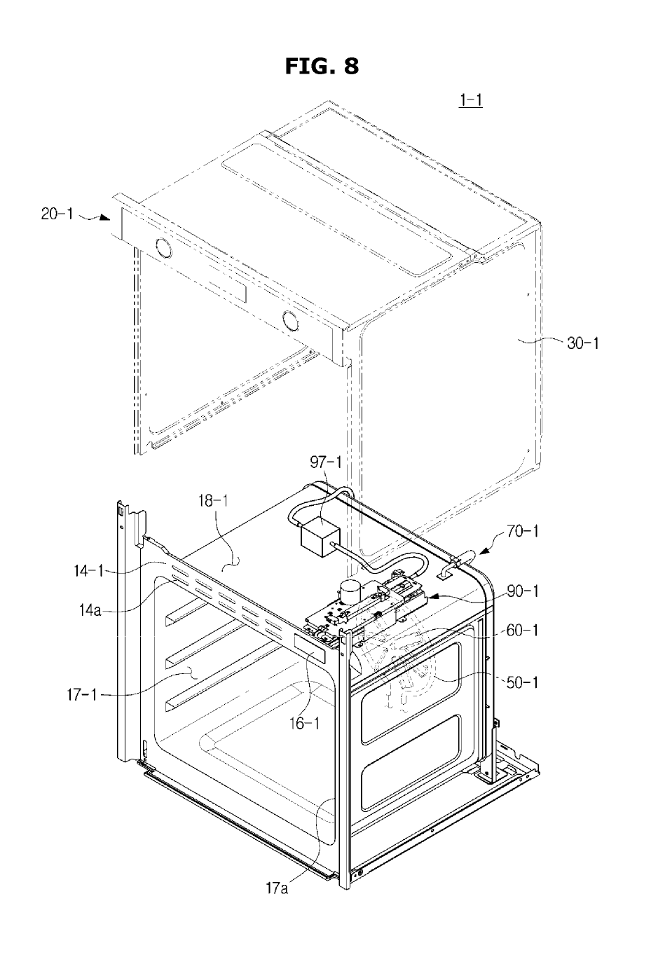

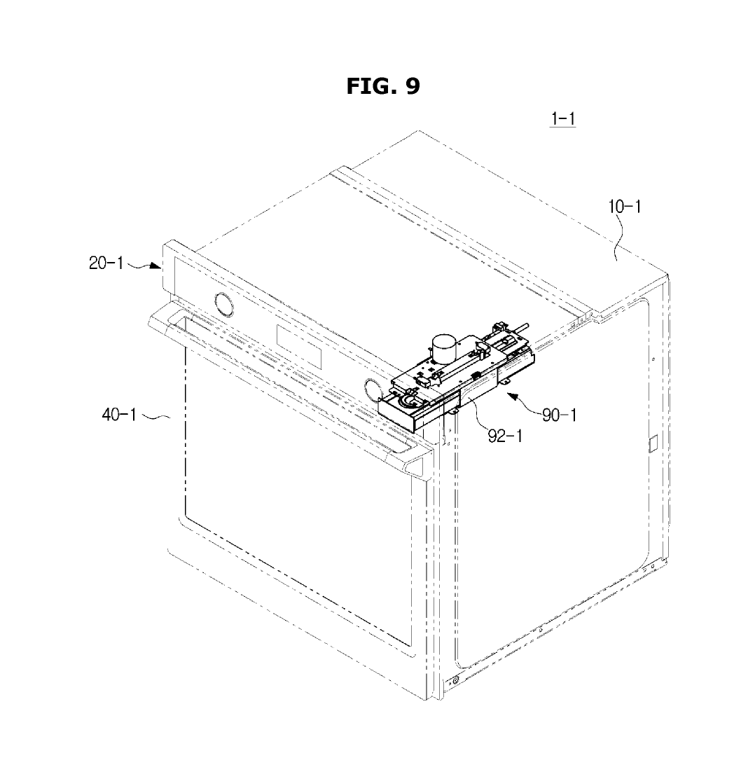

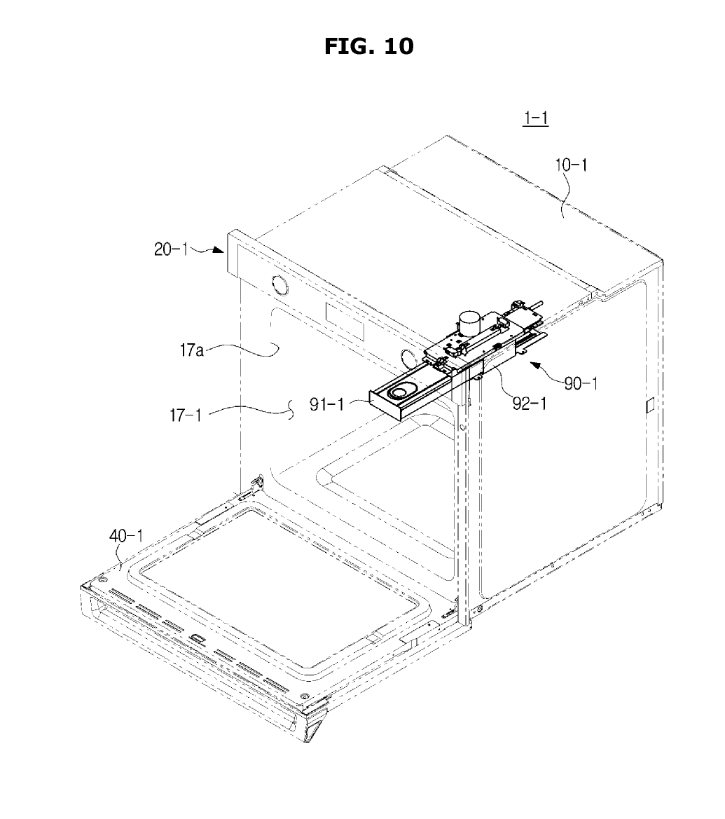

FIG. 7 is a perspective view showing a cooker according to another embodiment, FIG. 8 is a perspective view showing a cooker according to another embodiment when the cooker is partially dissembled, and FIGS. 9 and 10 show a state of a supply apparatus when a door according to another embodiment operates.

As shown in FIGS. 7 to 10, a cooker 1-1 according to another embodiment may be installed in the inside of a wall or a cabinet 2-1 so as to give a sense of unity with a kitchen space. The cabinet 201 in which the cooker 1-1 is installed may have an opening in the front portion to accommodate the cooker 1-1 through the opening.

The cooker 1-1 according to another embodiment may include a main body 10-1, a first space (hereinafter, referred to as a cooking room 17-1) in which cooking is performed, and a second space (hereinafter, referred to as a machine room 18-1) in which various kinds of electronic components are installed.

The main body 10-1 may further include a cover 30-1 forming an outer appearance of the cooker 1-1. The cover 30-1 may be coupled with the outer portion of the main body 10-1 such that a space is formed between the main body 10-1 and the cover 3-1.

In a front portion of the cover 30-1, a control panel 20-1 for enabling a user to control operations of the cooker 1-1 may be positioned.

On at least one of a upper portion, side portions, and a rear portion of the main body 10-1, a convection heater 50-1 for heating the cooking room 17 and a convection fan 60-1 may be positioned. Also, the main body 10-1 may include a steam generator 70-1 for generating steam and supplying the steam to the inside of the cooking room 17-1.

The convection heater 50-1 may provide heat for heating food existing in the inside of the heating room 17-1, and the convection fan 60-1 may convect heat generated by the convection heater 50-1 in the inside of the cooking room 17-1 or may circulate steam generated by the heat generator 70-1 in the inside of the cooking room 17-1. The steam generator 70-1 may be positioned on the main body 10-1 and connected to a supply apparatus 90-1 for supplying water or a solution such as a cleaning solution to the steam generator 70-1. The supply apparatus 90-1 may supply steam to the cooking room 17-1 of the main body 10-1. The supply apparatus 90-1 may be positioned on the upper portion of the main body 10-1.

In the upper portion of the main body 10-1, the machine room 18-1 may be positioned to accommodate components for controlling an inside environment of the cooking room 17-1. In the front, upper portion of the main body 10-1, the control panel 20-1 may be positioned to enable the user to control operations of the cooker 1-1.

The supply apparatus 90-1 may be positioned in the machine room 18-1 of the main body 10-1. The supply apparatus 90-1 may be positioned in a front, upper area of the machine room 18-1. The supply apparatus 90-1 may be movable in a front-back direction to be inserted into the machine room 18-1 or to be taken out of the machine room 18-1.

Meanwhile, the main body 10-1 may be in the shape of a hexahedron having an opening 17a in the front portion. Food may be put into or taken out of the cooking room 17-1 of the main body 10-1 through the opening 17a. The cooking room 17-1 in which food is put may be opened or closed by a door 40-1 coupled with the front portion of the main body 10-1. The door 40-1 may selectively open or close the cooking room 17.

The door 40-1 may be formed with a size corresponding to the front portion of the main body 10-1. The door 40-1 may be rotatably coupled with a front, lower end of the main body 10-1 to open and close the cooking room 17-1. The door 40-1 may be rotatably coupled with the front, lower end of the main body 10-1 by a hinge device (not shown). However, the concept of the present disclosure is not limited to this. For example, there are various methods in which the door 40-1 is opened or closed or various methods in which the door 40-1 is coupled with the main body 10-1.

The front portion of the main body 10-1 may include the opening 17a forming the cooking room 17-1. Also, a front frame 14-1 may be positioned above the opening 17a. The front frame 14-1 may be formed outside the cooking room 17-1. The front frame 14-1 may define at least one of the machine room 18-1. In the front frame 14-1, at least one hole 14a may be formed. The hole 14a may allow outside air to enter the inside of the machine room 18-1 of the cooker 1-1. In the other embodiment of the present disclosure, the front frame 14-1 may be formed above the opening 17a. However, the concept of the present disclosure is not limited to this. For example, the front frame 14-1 may be formed below or beside the opening 17a.

In the front frame 14-1, a supply apparatus installing opening 16-1 may be formed to install the supply apparatus 90-1 therein. The supply apparatus installing opening 16-1 may be formed in one end of the front frame 14-1. The supply apparatus 90-1 may be positioned behind the supply apparatus installing opening 16-1, that is, in the machine room 18-1 in such a way to be inserted into or taken out of the machine room 18-1 through the front frame 14-1.

The door 40-1 may be formed with a size and shape corresponding to the front portion of the main body 10-1. The door 40-1 may open and close the cooking room 17-1. The door 40-1 may open and close the opening 17a of the main body 10-1. The door 40-1 may be formed with a size and shape corresponding to the front portion of the main body 10-1 including the front frame 14-1 to cover the front frame 14-1 of the main body 10-1.

When the door 40-1 opens, the door 40-1 may rotate with respect to the lower end of the main body 10 so that a upper end of the door 40-1 moves downward toward a front direction to open the cooking room 17-1. When the door 40-1 opens, the supply apparatus 90-1 positioned in the front, upper portion of the main body 10-1 may be exposed in the front direction. When the door 10-1 is in an open state, the supply apparatus 90-1 may be exposed to the outside of the main body 10-1. The supply apparatus 90-1 may be movable so that when the door 40-1 opens, the supply apparatus 90-1 can be taken out in the front direction or inserted in the inside of the main body 10-1 to allow the user to supply a solution in the supply apparatus 90-1.

Also, when the door 40-1 is closed, the door 40-1 may rotate with respect to the lower end of the main body 10 so that the upper end of the door 40-1 moves upward toward a rear direction to close the cooking room 17-1. When the door 40-1 is closed, the supply apparatus 90-1 may be inserted into the inside of the main body 10-1 and thus covered by the door 40-1. When the door 40-1 is closed, the supply apparatus 90-1 may be hidden by the door 40-1 so that the supply apparatus 90-1 is not exposed to the outside of the cooker 1-1.

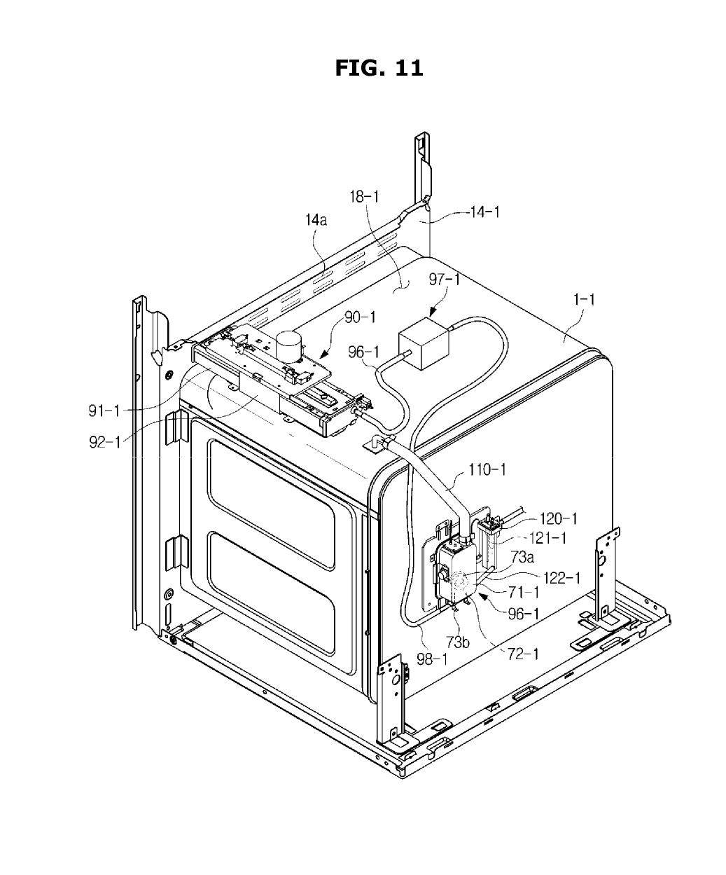

FIG. 11 is a rear perspective view of a cooker according to another embodiment when the cooker is partially dissembled.

As shown in FIG. 11, the supply apparatus 90-1 may be connected to the steam generator 70-1. The steam generator 70-1 may be positioned on the rear surface of the main body 10-1.

The steam generator 70-1 may heat a solution supplied through the supply apparatus 90-1 to generate steam, and supply the steam to the inside of the cooking room 17-1. The steam generator 70-1 may be connected to an auxiliary steam generator 120-1. In the auxiliary steam generator 120-1, a water level sensor 121-1 may be disposed to measure a water level of the solution stored in the inside of the steam generator 70-1.

The supply apparatus 90-1 may be connected to the steam generator 70-1 through at least one pump 97-1. The supply apparatus 90-1 may be connected to the pump 97-1 through a connecting pipe 96-1. Also, the steam generator 70-1 may be connected to the pump 97-1 through a supply pipe 98-1, and the solution stored in the supply apparatus 90-1 may be transferred to the steam generator 70-1.

The steam generator 70-1 may include a steam container 71-1 for storing a solution supplied from the supply apparatus 90-1, a heater 72-1 for heating the solution stored in the inside of the steam container 71-1, and a steam supply pipe 110-1 for guiding steam generated by being heated by the heater 72-1 to the inside of the cooking room 17-1. The steam supply pipe 110-1 may be connected to the upper portion of the main body 10-1.

The heater 72-1 positioned in the inside of the steam container 71-1 may include a heating portion 73a wound in the shape of a coil, and an electrode portion 73b extending from the heating portion 73a to the outside of the steam container 71-1. The electrode portion 73b may be connected to an external power source (not shown) to cause current to flow to the heating portion 73a, thereby raising the temperature of the heating portion 73a.

The steam generator 70-1 may be connected to the auxiliary steam generator 120-1 through a flow path pipe 122-1. The flow path pipe 122-1 may cause a solution entered the steam generator 70-1 to enter the auxiliary steam generator 12-1 simultaneously.

In the auxiliary steam generator 120-1, like the above-described embodiment, a water level sensor 121-1 may be disposed to measure a water level of the solution stored in the inside of the steam generator 70-1. Also, like the above-described embodiment, the water level sensor 121-1 of the cooker 1-1 according to the other embodiment may include a ground electrode and a sensing electrode. When a solution stored in the inside of the steam generator 70-1 reaches a predetermined water level, the sensing electrode of the water level sensor 121-1 may contact the solution to generate a voltage.

The supply apparatus 90-1 may be connected to the pump 97-1. The pump 97-1 may include a supply pump and a drain pump, like the above-described embodiment, and be positioned on the upper surface of the main body 10-1. The pump 97-1 may be disposed around the supply apparatus 90-1. The pump 97-1 may be positioned in an area of the machine room 18-1. The pump 97-1 may be connected to the steam container 71-1 of the steam generator 70-1.

The supply apparatus 90-1 may include a housing 92-1 fixed in the machine room 18-1 of the main body 10-1, and a storage unit 91-1 that is movable to be inserted into or taken out of the housing 92-1.

The housing 92-1 of the supply apparatus 90-1 may be positioned around a front area of one side of the machine room 18-1. The housing 92-1 may be positioned in a front area of the machine room 18-1. The housing 92-1 may be fixed in the front area of the machine room 18-1.

The storage unit 91-1 may accommodate a solution supplied from the outside. The storage unit 91-1 may be connected to the pump 97-1 through the connecting pipe 96-1, and the pump 97-1 may be connected to the steam container 71-1 of the steam generator 70-1 through the supply pipe 98-1.

The supply pipe 98-1 may supply a solution stored in the supply apparatus 90-1 and supplied from the pump 97-1 to the steam generator 70-1. In the other embodiment, the supply apparatus 90-1 may be connected to the steam generator 70-1 through the connecting pipe 96-1, the pump 97-1, and the supply pipe 98-1. However, the concept of the present disclosure is not limited to this. For example, a solution may move by its own weight from the supply apparatus 90-1 located higher than the steam generator 70-1.

The cookers 1 and 1-1 according to the embodiments may further include a controller.

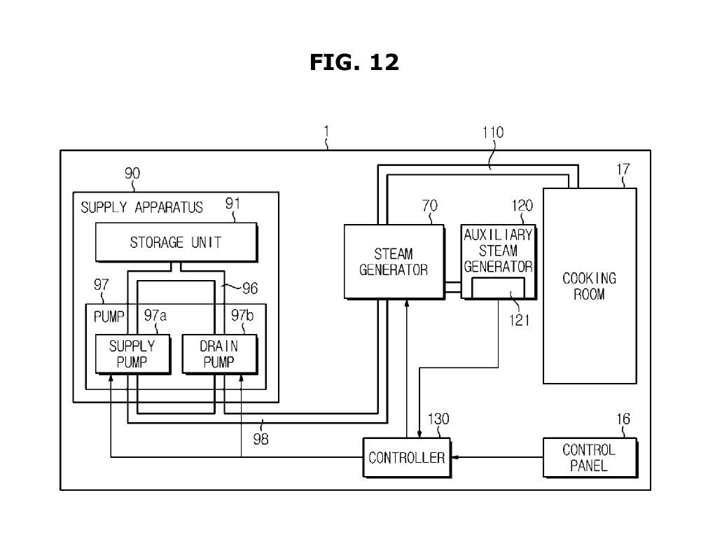

The controller may be positioned adjacent to the control panels 20 and 20-1, however, the controller may be positioned at any location in the cookers 1 and 1-1. Hereinafter, for convenience of description, a control method of the controller included in the cooker 1 will be described with reference to FIG. 12. However, the control method of the controller, which will be described below, may be also applied to the cooker 1-1 according to the other embodiment. FIG. 12 is a control block diagram of a cooker according to an embodiment.

Components shown in FIG. 12 may be the same as the corresponding ones described above with reference to FIGS. 1 to 6, and accordingly, overlapping descriptions thereof will be omitted.

A controller 130 may control the components of the cooker 1.

The controller 130 may be implemented with memory (not shown) storing algorithms for controlling operations of the components in the cooker 1 or data for programs embodying the algorithms, and a processor (not shown) for performing the above-described operations using the data stored in the memory. The memory and processor may be implemented as separate chips. Alternatively, the memory and processor may be implemented as a single chip.

The controller 130 may determine whether the slider 93 is taken out in the front direction from the main body 10 or inserted into the inside of the main body 10, based on the result of sensing by a sensor for sensing a movement of the slider 93.

Also, the controller 130 may control the supply apparatus 90 to supply a solution stored in the storage unit 91 to the steam generator 70 or to remove a solution remaining in the steam generator 70.

More specifically, the controller 130 may perform a water supply process by operating the supply pump 97a of the steam generator 70 and stopping operating the drain pump 97b to supply a solution stored in the storage unit 91 to the steam generator 70.

When the supply pump 97a operates and the drain pump 97b stops operating, the solution stored in the storage unit 91 may pass through the connecting pipe 96, the supply pump 97a, and the supply pipe 98 sequentially to be supplied to the steam generator 70.

When a cleaning solution for removing impurities is put in the storage unit 91 by a user, a part of the cleaning solution existing in the storage unit 91 may be supplied to the steam generator 70 since the supply pump 97a operates and the drain pump 97b stops operating, and accordingly, the steam generator 70 may be cleaned. However, although a cleaning solution of high concentration enters the steam generator 70, the concentration of the cleaning solution entered the steam generator 70 may be lowered due to impurities or other solutions existing in the steam generator 70. Therefore, the controller 130 according to an embodiment may again supply the cleaning solution of low concentration to the storage unit 91 to mix it with the cleaning solution of high concentration not supplied to the steam generator 70.

For this, the controller 130 may perform a drain process by stopping operating the supply pump 97a of the steam generator 70 and operating the drain pump 97b, and again supply a solution remaining in the steam generator 70 to the storage unit 91.

When the supply pump 97a stops operating and the drain pump 97b operates, the solution remaining in the steam generator 70 may pass through the supply pipe 98, the drain pump 97b, and the connecting pipe 96 sequentially to be supplied to the storage unit 91.

Accordingly, the cleaning solution of low concentration remaining in the steam generator 70 may be supplied to the storage unit 91 to be mixed with the cleaning solution of high concentration stored in the storage unit 91, so that the concentration of the cleaning solution may increase.

Meanwhile, when the supply pump 97a stops operating and the drain pump 97b operates, the solution may be collected in the connecting pipe 96 connected to the supply pump 97a. The controller 130 according to another embodiment may operate the supply pump 97a and the drain pump 97b simultaneously for a predetermined first time in a final stage of the drain process to remove the solution collected in the connecting pipe 96 during the drain process. In this case, the solution collected in the connecting pipe 96 may circulate.

Then, the controller 130 may again perform a supply process by operating the supply pump 97a and stopping operating the drain pump 97b to supply the cleaning solution of high concentration to the steam generator 70. Accordingly, the steam generator 70 may be washed more cleanly.

Also, the controller 130 may estimate a water level of a solution stored in the steam generator 70 based on the result of sensing by the water level sensor 121 of the auxiliary steam generator 120.

For example, when the water level sensor 121 senses a water level at a certain time, the controller 130 may determine that the steam generator 70 is fully filled when a predetermined second time (for example, 30 seconds) elapses from when the water level sensor 121 senses the water level.

According to another example, when the water level sensor 121 continuing to sense a water level senses no water level at a certain time, the controller 130 may determine that the solution stored in the storage unit 91 is completely removed when a predetermined second time (for example, 30 seconds) elapses from when the water level sensor 121 senses no water level.

Also, the controller 130 may control the steam generator 70 to generate steam. For this, the controller 130 may operate the convection heater 50 and the convection fan 60.

Also, the controller 130 may stop operating the steam generator 70 to generate no steam.

The controller 130 may control operations of the cooker 1 based on a user command received through the control panel 20.

When the controller 130 receives a command for entering a washing mode through the control panel 20, the controller 130 may enter the washing mode which will be described later to perform a process of supplying and draining a cleaning solution. Also, when the controller 130 receives a command for entering a rinsing mode through the control panel 20, the controller 130 may enter the rinsing mode to perform a process of supplying and draining water.

Also, the controller 130 may control the display 22 to display an icon informing that cleaning is needed. For example, when the steam generator 70 has generated steam for 12 hours or more, the controller 130 may control the display 22 to display an icon informing that cleaning is needed. Also, when the steam generator 70 has generated steam for 14 hours or more, the controller 130 may control the display 22 to display an icon informing that cleaning is needed, and stop operating the steam generator 70 so that the steam generator 70 does not generate steam any longer.

The controller 130 may include a software component and/or a hardware component, such as Field Programmable Gate Array (FPGA) and Application Specific Integrated Circuit (ASIC).

At least one component may be added or omitted to correspond to the performances of the components of the cooker 1 shown in FIG. 12. Also, it will be easily understood by one of ordinary skill in the art that the relative locations of the components can be changed to correspond to the performance or structure of the system.

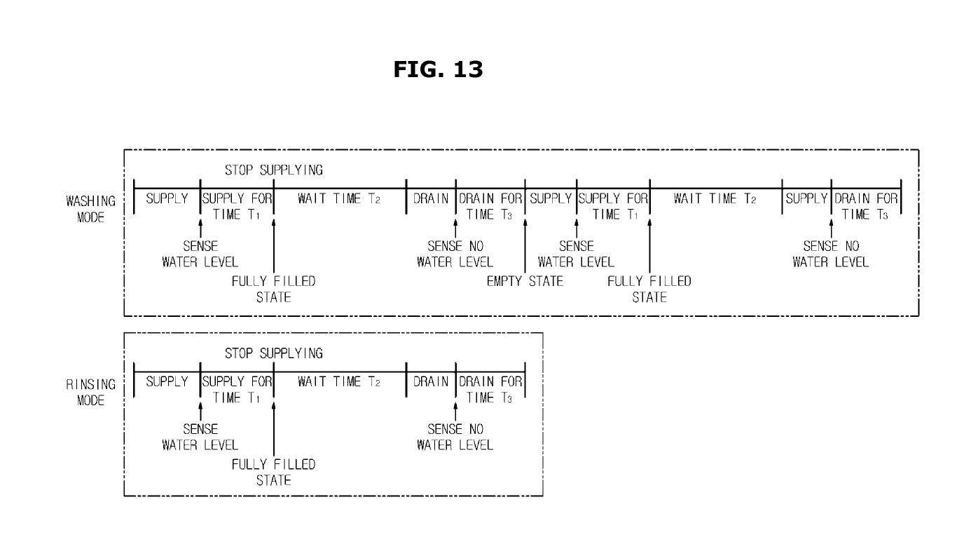

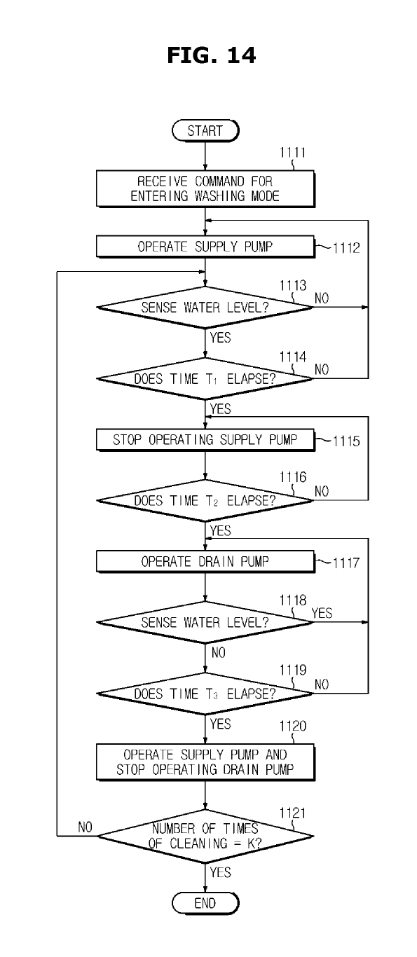

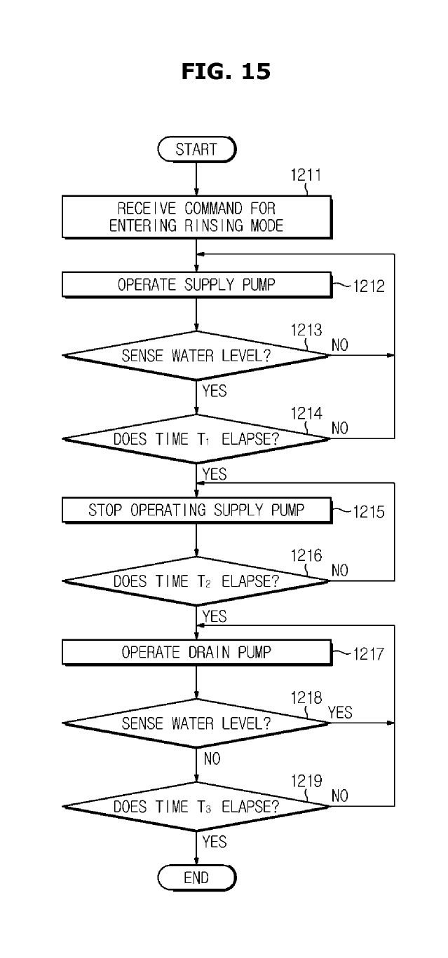

Hereinafter, a control method of the cooker 1 according to an embodiment will be described with reference to FIGS. 13 to 15. The control method of the cooker 1, which will be described below, may be applied to the cooker 1-1 according to another embodiment described above with reference to FIGS. 7 to 11. FIG. 13 is a schematic diagram for describing a control process of a cooker according to an embodiment when a washing mode and a rinsing mode are performed. FIG. 14 is a flowchart illustrating a control method of a cooker according to an embodiment when the washing mode is performed. FIG. 15 is a flowchart illustrating a control method of a cooker according to an embodiment when the rinsing mode is performed.

Referring to FIGS. 13 and 14, when the controller 130 receives a command for entering a washing mode through the control panel 20 (operation 1111), the controller 120 may enter the washing mode to operate the supply pump 97a and stop operating the drain pump 97b. Accordingly, a cleaning solution stored in the storage unit 91 may be supplied to the steam generator 70 (operation 1112).

Also, when the controller 130 receives a command for entering the washing mode, the controller 130 may control the steam generator 70 to stop generating steam.

Before operating the supply pump 97a, the controller 130 may control the display 22 to inform that a solution accommodated in the storage unit 91 needs to be replaced with a new cleaning solution.

Successively, the controller 130 may monitor the water level sensor 121, and when the water level sensor 121 senses a water level (“YES” in operation 1113), the controller may supply the cleaning solution for a predetermined time T1 from when the water level sensor 121 senses the water level (“NO” in operation 1114). When the predetermined time T1 elapses (“YES” in operation 1114), the controller 130 may determine that the steam generator 70 is fully filled, and stop supplying the cleaning solution. To stop supplying the cleaning solution, the controller 130 may stop operating the supply pump 97a (operation 1115). When the cleaning solution is no longer supplied, a part of the cleaning solution stored in the storage unit 91 may be supplied to the steam generator 70.

Successively, the controller 1320 may wait a predetermined time T2 such that the cleaning solution is sufficiently mixed with impurities in the steam generator 70 (operation 1116). Then, when the predetermined time T2 elapses, the controller 130 may operate the drain pump 97b and stop operating the supply pump 97a such that the solution whose concentration has been lowered is again mixed with the solution of high concentration stored in the storage unit 91 (operation 1117). Accordingly, the cleaning solution remaining in the steam generator 70 may be again supplied to the storage unit 91.

Since the cleaning solution remaining in the steam generator 70 is again supplied to the storage unit 91, the concentration of the cleaning solution may increase.

Successively, the controller 130 may monitor the water level sensor 121, and when the water level sensor 121 continuing to sense a water level senses no water level (“NO” in operation 1118), the controller 130 may perform a drain process for a predetermined time T3 from when the water level sensor 121 senses no water level (“NO” in operation 1119). When the predetermined time T3 elapses (“YES” in operation 1119), the controller 130 may determine that the steam generator 70 is empty, and may stop the drain process.

Then, the controller 130 may supply the cleaning solution to the steam generator 70 until the steam generator 70 is fully filled such that the cleaning solution of high concentration stored in the storage unit 91 is again supplied to the steam generator 70. To stop the drain process and supply the cleaning solution, the controller 130 may again operate the supply pump 97a and stop operating the drain pump 97b (operation 1120).

When the washing mode is performed, the controller 130 according to an embodiment may perform a process of supplying and draining a cleaning solution by a predetermined number k of times. When the process of supplying and draining the cleaning solution is repeated by the predetermined number k of times, the time T1 for which the cleaning solution is supplied may change according to a setting.

Meanwhile, since some cleaning solution may remain in the steam generator 70 after the washing mode is performed, a process of rinsing the cleaning solution remaining in the steam generator 70 with water may be needed.

For this, the controller 130 according to an embodiment may receive a command for entering the rinsing mode (operation 1211), and enter the rinsing mode to operate the supply pump 97a and stop operating the drain pump 97b (operation 1212), as shown in FIGS. 13 and 15. Accordingly, water stored in the storage unit 91 may be supplied to the steam generator 70. Also, when the controller 130 receives a command for entering the rinsing mode, the controller 130 may control the steam generator 70 to stop supplying steam.

Before operating the supply pump 97a, the controller 130 may control the display 22 to inform that a solution accommodated in the storage unit 91 needs to be replaced with water.

Successively, the controller 130 may monitor the water level sensor 121, and when the water level sensor 121 senses a water level (“YES” in operation 1213), the controller 130 may supply water for a predetermined time T1 from when the water level sensor 121 senses the water level (“NO” in operation 1214). When the predetermined time T1 elapses (“YES” in operation 1214), the controller 130 may determine that the steam generator 70 is fully filled, and stop supplying water. To stop supplying water, the controller 130 may stop operating the supply pump 97a (operation 1215).

Thereafter, the controller 130 may wait a predetermined time T2 such that the steam generator 70 is sufficiently rinsed with water (operation 1216). When the time T2 elapses, the controller 130 may operate the drain pump 97b to drain water from the steam generator 70, and stop operating the supply pump 97a (operation 1217). Accordingly, water remaining in the steam generator 70 may be again supplied to the storage unit 91.

Successively, the controller 130 may monitor the water level sensor 121, and when the water level sensor 121 continuing to sense a water level senses no water level (“NO” in operation 1218), the controller 130 may drain water for a predetermined time T3 from when the water level sensor 121 senses no water level (“NO” in operation 1219). When the time T3 elapses (“YES” in operation 1219), the controller 130 may determine that the steam generator 70 is empty, and stop draining water.

A user may check water drained to the storage unit 91 to determine cleanliness of the water, thereby determining whether to again enter the rinsing mode. When the user determines that rinsing is more needed, the user may again operate the control panel 20 to input a command for entering the rinsing mode.

Meanwhile, entering the rinsing mode may not necessarily require operating the control panel 20. For example, the controller 130 may enter the rinsing mode automatically after the supply process and the drain process (operations 1112 and 1121 in FIG. 14) are performed by the predetermined number k of times in the washing mode.

As such, when the cooker 1 according to an embodiment repeats the supply process and the drain process by the predetermined number k of time in the washing mode, the cleaning solution of high concentration supplied to the storage unit 91 may continue to be supplied to the steam generator 70.

Also, when the cooker 1 according to an embodiment performs a supply process and a drain process in the rinsing mode, clean water supplied to the storage unit 91 may rinse the steam generator 70 to effectively remove impurities or a cleaning solution existing in the steam generator 70.

Meanwhile, the disclosed embodiments may be implemented in the form of recording medium storing commands that are executable by a computer. The commands may be stored in the form of program code, and when executed by a processor, the commands may generate a program module to perform operations of the disclosed embodiments. The recording medium may be implemented as computer-readable recording medium.

The computer-readable recording medium may include all kinds of recording media storing commands that can be interpreted by a computer. For example, the computer-readable recording medium may be Read Only Memory (ROM), Random Access Memory (RAM), a magnetic tape, a magnetic disc, flash memory, an optical data storage device, etc.

While the present disclosure has been particularly described with reference to exemplary embodiments, it should be understood by those of skilled in the art that various changes in form and details may be made without departing from the spirit and scope of the present disclosure.

1. A cooker comprising:
a cooking room;
a steam generator configured to generate steam, and to supply the steam to the cooking room;
a water level sensor configured to sense a water level of a cleaning solution stored in the inside of the steam generator;
a supply apparatus including a storage unit configured to accommodate the cleaning solution, a supply pump configured to supply the cleaning solution accommodated in the storage unit to the steam generator, and a drain pump configured to supply the cleaning solution remaining in the steam generator to the storage unit; and
a controller configured to control operations of the supply pump and the drain pump,
wherein the controller operates the supply pump in a washing mode, operates the drain pump when the cleaning solution is fully filled in the steam generator, and again operates the supply pump when the cleaning solution is removed from the steam generator.

2. The cooker of claim 1, wherein when a predetermined first time elapses after the water level of the cleaning solution is sensed, the controller determines that the cleaning solution is fully filled in the steam generator.

3. The cooker of claim 1, wherein when the cleaning solution is fully filled in the steam generator, the controller stops operating the supply pump.

4. The cooker of claim 1, wherein the controller repeatedly performs a process of operating the supply pump by a predetermined number of times and operating the drain pump when the cleaning solution is fully filled in the steam generator.

5. The cooker of claim 1, further comprising a display configured to display an operation state of the cooker, wherein the controller controls the display to inform a user that the cleaning solution stored in the storage unit needs to be replaced with a new cleaning solution.

6. The cooker of claim 1, wherein the supply apparatus further comprises a connecting pipe diverging from the storage unit and connected to the supply pump and the drain pump, and a supply pipe diverging from the steam generator and connected to the supply pump and the drain pump.

7. The cooker of claim 1, wherein the water level sensor is positioned in an auxiliary steam generator provided separately from the steam generator and connected to the steam generator through a flow path pipe.

8. The cooker of claim 1, further comprising a control panel configured to receive a command for entering a washing mode,
wherein when the control panel receives the command for entering the washing mode, the controller operates the supply pump.

9. The cooker of claim 1, wherein the water level sensor comprises an electrode configured to generate a voltage when the electrode contacts the cleaning solution stored in the inside of the steam generator, thereby sensing the water level.

10. A control method of a cooker, comprising:
operating a supply pump for supplying a cleaning solution accommodated in a storage unit to a steam generator for generating steam, in a washing mode;
operating a drain pump for supplying the cleaning solution remaining in the steam generator to the storage unit, when the cleaning solution is fully filled in the steam generator; and
again operating the supply pump.

11. The control method of claim 10, wherein the operating of the drain pump comprises determining that the cleaning solution is fully filled in the steam generator, when a predetermined first time elapses after a water level of the cleaning solution is sensed.

12. The control method of claim 10, further comprising again operating the drain pump when the cleaning solution is fully filled in the steam generator.

13. The control method of claim 10, further comprising, before operating the supply pump, informing a user that the cleaning solution stored in the storage unit needs to be replaced with a new cleaning solution.

14. The control method of claim 10, wherein the operating of the drain pump comprises operating the drain pump after a predetermined first time elapses, when the cleaning solution is fully filled in the steam generator.

15. The control method of claim 10, wherein the operating of the drain pump comprises stopping operating the supply pump when the cleaning solution is fully filled in the steam generator.
